(19) United States
(12) Patent Application Publication
(10) Pub. No.: US 2017/0322762 A1
(43) Pub. Date: Nov. 9, 2017

(54) COLLABORATION SESSION WITH DESIGNATED CONTROL PEN

(71) Applicant: SMART TECHNOLOGIES ULC, Calgary (CA)

(72) Inventors: Nghiep Duy Duong, Sammamish, WA (US); Brian Heath Ward, Seattle, WA (US)

(21) Appl. No.: 15/147,225

(22) Filed: May 5, 2016

(51) Int. Cl. G06F 3/14; G06F 3/0487; G06F 3/0354

(52) U.S. Cl. CPC G06F 3/1454; G06F 3/03545; G06F 3/0487

(57) ABSTRACT

A method for providing a collaboration session using a designated control pen includes receiving graphical content from either a first computing device associated with a first pen tool or a second computing device associated with a second pen tool. A request can be received from the first computing device to designate the first pen tool as the control pen. In response to the request, the first pen is designated as the control pen and the second pen is disabled so long as the first pen tool retains the control pen designation. The graphical content can be modified based on the interactions made with the designated control pen at the first display area. The modified graphical content is globally displayed, which includes providing the modified graphical content to the second computing device for display at the second display area.

### TECHNICAL FIELD

The disclosed embodiments relate generally to display systems with multiple display devices, and, in particular to hosting a collaboration session with the multiple display devices using a designated control pen.

### BACKGROUND

Display systems typically include a display and optionally input devices. An interactive display system (“interactive system”) can include as an input device a touchscreen configured to display an interactive canvas onto which digital content is presented. Users can interact with the system using the touchscreen, e.g., to provide input. The interactive system can detect pointer interactions between the interactive canvas and a pointing device, such as a pen tool, or a user's finger or hand. Content can be added, modified, or erased based on the pointer interactions.

In some display systems, multiple users can add digital content to an interactive canvas. In such systems, a plurality of computing devices, each having a corresponding display, can connect to a common host server. The host server executes a collaboration application that presents the interactive canvas to each of the users via their corresponding computing devices. The collaboration application allows the users to work together in a common session. One challenge with these sessions, however, is that users can navigate the collaboration application independent of the other users which can make collaboration cumbersome. For example, a user may inadvertently erase content that was added to the interactive canvas by another user.

### BRIEF DESCRIPTION OF THE DRAWINGS

FIG. 1 is a block diagram illustrating an overview of an environment in which a collaborative system with a designated control pen can be implemented.

FIG. 2 is a block diagram illustrating components of a computing device in which aspects of the collaborative system can be implemented.

FIGS. 3A-4D are display diagrams illustrating some implementations of collaboration with a designated control pen.

FIGS. 5A-5C are flow diagrams illustrating processes used in some implementations of collaboration with a designated control pen.

### DETAILED DESCRIPTION

Embodiments are described for providing a collaboration session using an input device (“pen tool”) that is designated as a control pen. In various embodiments, the control pen is a designation that is dynamically assigned to either a first pen tool associated with a first computing device or a second pen tool associated with a second computing device. The pen tools are configured to interact with a corresponding display area. In response to a request from the first computing device, the first pen tool is designated as the control pen and the second pen tool is disabled so long as the first pen tool retains the control pen designation. When the first pen tool has the control pen designation, it can be used to modify the graphical content, but the second pen tool cannot. This modified graphical content is provided to the second computing device for display at its corresponding display area. The modified graphical content can be provided in real-time or near real-time while it is being modified via the designated control pen.

In some embodiments, the first pen tool can be a physical input device (“physical pen”) that is shaped like an actual pen or marker and that can be stowed in a physical pen holder near or at a first display area associated with the first computing device. The second pen tool can be a virtual pen that can be stowed in a virtual pen holder that is graphically displayed at the second display area. The physical pen can be designated as the control pen when it is removed from the physical pen holder (i.e., picked up). The virtual pen can be designated as the control pen when it is removed from the virtual pen holder. In some embodiments, the virtual pen is automatically disabled when the physical pen is picked up, regardless of whether it was currently designated as the control pen. In such embodiments, the physical pen can serve as a master control pen having the highest priority that can take control away from any another pen. In other embodiments, the virtual pen can serve as a master control pen, or there is no master control pen in a given session.

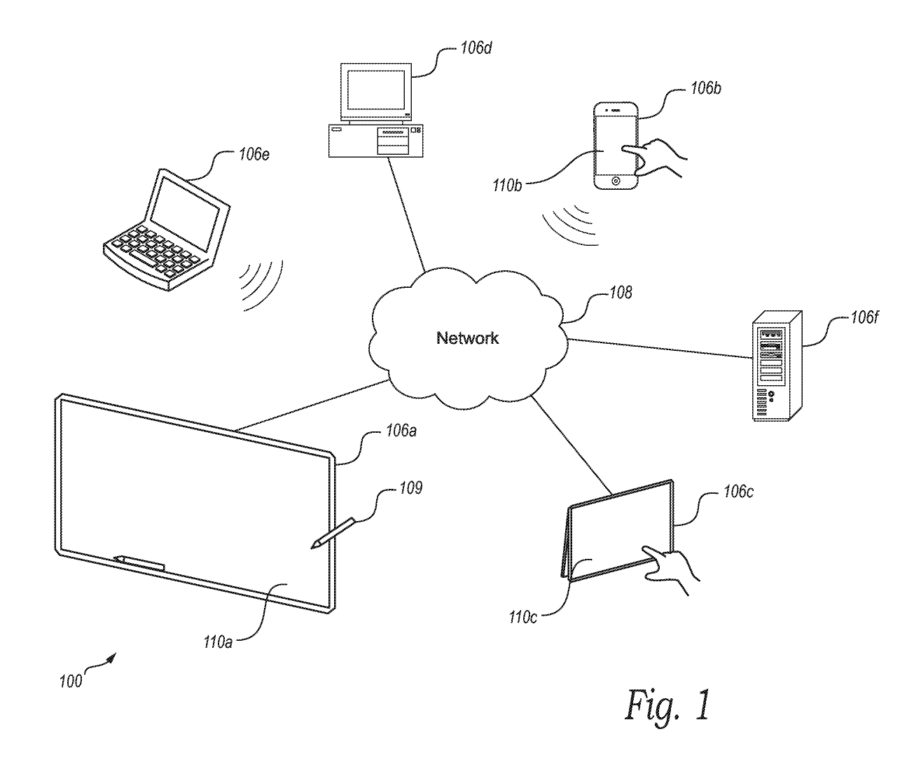

Various details are set forth in the following description, FIGS. 1-5 provide a thorough understanding of various embodiments of the disclosed technology. Other details describing well-known structures, systems, and methods, however, are not set forth below to avoid unnecessarily obscuring the description of the various embodiments of the technology. In the Figures, identical reference numbers identify at least generally similar elements.

FIG. 1 is a block diagram illustrating an overview of an environment in which a collaborative system 100 with a designated control pen can be implemented. The system 100 includes a plurality of computing devices 106a-f. The computing device 106a-f are connected to one another through a network 108. The network 108 may be wired or wireless or a combination thereof. The computing devices 106a-f can enable participants of the session to receive, view, store, and/or otherwise interact with graphical content. A server device 106f or multiple server devices (not shown) can be configured to facilitate (e.g., host) a collaboration session between the various computing devices 106a-e, such as by exchanging and processing communications over the network 108, storing a central copy of a digital canvas, globally updating graphical content, etc. As described in greater detail below, one of the computing devices, such as the computing device 106a, can be designated as the collaboration session host. A collaboration session host can provide the main presentation screen at which a digital canvas is displayed, such as during a live presentation by a presenter (e.g., a teacher, a lecturer, a meeting facilitator, etc.) Examples of well-known computing devices, systems, environments, and/or configurations that may be suitable for use with the technology include, but are not limited to, personal computers, server computers, handheld or laptop devices, cellular telephones, wearable electronics, tablet devices, multiprocessor systems, microprocessor-based systems, set-top boxes, programmable consumer electronics, network PCs, minicomputers, mainframe computers, databases, distributed computing environments that include any of the above systems or devices, or the like.

At least some of the computing devices 106a-f include display devices, such as a touchscreen, a video projector, an LCD or LED display, or the like. The display devices have a corresponding display area 110. In the illustrated embodiment, an interactive display device 106a has a first display area 110a (e.g., a presentation screen), a mobile device 106b has a second display area 110b, and a tablet computer 106c has a third display area 110c In some embodiments, an interactive display device can include, for example, Smart kapp IQ™, Smart kapp IQ Pro™, Smart Board 4000 series, or a Smart Board 6000 series display available from assignee SMART Technologies, ULC of Calgary, Alberta, Canada. In various embodiments, the interactive displays can include an interactive display or system described in U.S. Pat. Nos. 5,448,263; 6,141,000; 6,337,681; 6,747,636; 6,803,906; 7,236,162; 7,232,986; 7,274,356; 8,456,45; 8,619,027; and 9,288,440, all assigned to SMART Technologies ULC, and all of which are incorporated by reference herein in their entireties.

In operation, the display devices 106a-c are configured to detect for interactions made by a participant using a pen tool, which may be an active or passive pointer. An active pen is a pen that is powered by a power source such as a battery, a capacitor, and/or a kinetic energy harvester. An active pen can emit energy, such as in the form of infrared light (e.g., IR light), an electric field, and/or a magnetic field, that can be detected by a suitable sensor proximate or integral with a corresponding display area. Passive pens do not actively emit energy but may contain reflectors and other passive elements. A pen tool that is identifiable as such by at least one of computing device 106a-c, and can be physically held and manipulated by a user in proximity to a display area can be referred to as a known physical pen (e.g., a stylus, an interactive marker, etc.). A known physical pen such as pen 109 can include, for example, an interactive marker or a stylus that can make markings in the form of virtual ink. In some embodiments, a known physical pen, such as a dry erase marker, may dispense actual ink that can be detected at a display area such as display area 110a. A computing device can distinguish a known physical pen or marker from an unknown pen or marker, such as a stylus (e.g., a pointer or stick), a conventional dry erase marker, an eraser, a finger, etc.

A pen tool that is not identifiable as a known physical pen by any of devices 106a-c, or is not physically held and manipulated by a user can be referred to as a virtual pen. A virtual pen can include, for example, a user's finger and/or a graphical curser (displayed, e.g., in the shape of pen tool). Neither a known physical pen nor a virtual pen need to take the shape of an actual pen. In some embodiments, a display area can interact with both physical and virtual pens. A computing device can distinguish between a known physical pen and a virtual pen, as described in greater detail below

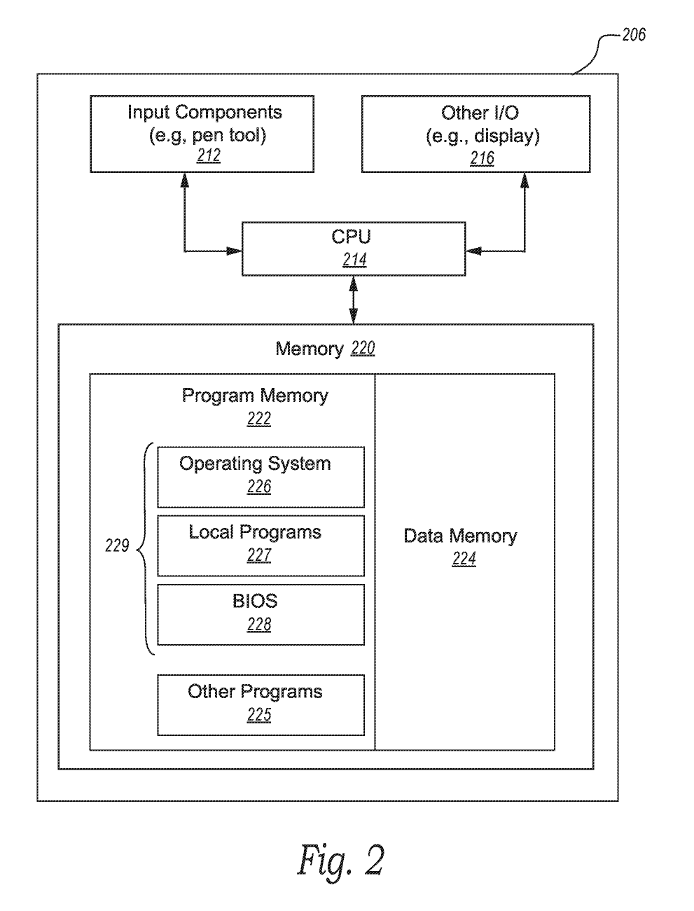

FIG. 2 is block diagram illustrating components of a computing device 206, such as the interactive display device 106a (FIG. 1). The computing device 206 includes input components 212 configured to provide input to a processor such as CPU 214, notifying it of actions. The actions are typically mediated by a hardware controller that communicates according to one or more communication protocols. The input components 212 can include, for example, a mouse, a keyboard, a touchscreen, an infrared sensor, a touchpad, a wearable input device, a pointer device, a camera- or image-based input device, a pointer, and/or one or more microphones.

The CPU 214 can be a single processing unit or multiple processing units in a device or distributed across multiple devices. The CPU 214 can be coupled to other hardware components via, e.g., a bus, such as a PCI bus or SCSI bus. Other input/output components 216 include communication components, such as a wireless transceiver (e.g., a WiFi or Bluetooth transceiver) and/or a network card. Such communication components can enable communication over wired or wireless (e.g., point-to point) connections with other devices. A network card can enable the computing device 206 to communicate over the network 108 (FIG. 1) using, e.g., TCP/IP protocols. The input/output components 216 may also include a display, a video card, audio card, USB, firewire or other external components or devices, such as a camera, printer, CD-ROM drive, DVD drive, disk drive, Blu-Ray device, and/or speakers.

The CPU 214 can have access to a memory 220. The memory 220 includes volatile and non-volatile components which may be writable or read-only. For example, the memory can comprise CPU registers, random access memory (RAM), read-only memory (ROM), and writable non-volatile memory, such as flash memory, hard drives, floppy disks, CDs, DVDs, magnetic storage devices, tape drives, device buffers, and so forth. The memory 220 stores programs and software in programming memory 222 and associated data (e.g., configuration data, settings, user options or preferences, etc.) in data memory 224. The programming memory 222 contains an operating system 226, local programs 227, and a basic input output system (BIOS) 228, all of which can be referred to collectively as general software 229. The operating system can include, for example, Microsoft Windows™, Apple iOS, Apple OS X, Linux, Android, and the like. The programming memory 222 also contains other programs and software 225 configured to perform various operations.

The various programs and software can be configured to detect interactions with physical and/or virtual pens. Further, the programs and software can be configured to display a digital canvas at a display area. A digital canvas is a two-dimensional workspace onto which input in the form of digital ink, graphical objects or other digital objects may be made by participants of a collaboration session.

The programs and software 225 can also be configured to host a collaboration application on a host device, such as the server device 106f (FIG. 1), via a network connection. The collaboration application enables multiple computing devices to join the collaboration session using, e.g., a web browser application. Each collaboration session can have a unique identifier (e.g., a unique URL address) associated with it, allowing multiple users to remotely connect to the collaboration session. The collaboration application can store graphical content on the digital canvas. The participants of the session can manipulate the digital canvas by e.g., adjusting the background color, zoom-level or zoom area, etc. according to their preferences. In some embodiments, the participants of the session may be made to follow the view of a participant who is in control of the control pen (e.g., in “a follow-me” mode as described in U.S. Pat. No. 9,288,440 assigned to the assignee of the subject application). A participant who is in control of the control pen can be referred to as a presenter.

Those skilled in the art will appreciate that the components illustrated in FIGS. 1 and 2 described above, and in each of the diagrams discussed below, may be altered in a variety of ways. For example, the order of the logic may be rearranged, substeps may be performed in parallel, illustrated logic may be omitted, other logic may be included, etc. For example, blocks shown in dashed lines may be excluded from some implementations. However, applicants do not intend to say that only blocks shown in dashed lines may be excluded from some implementations.

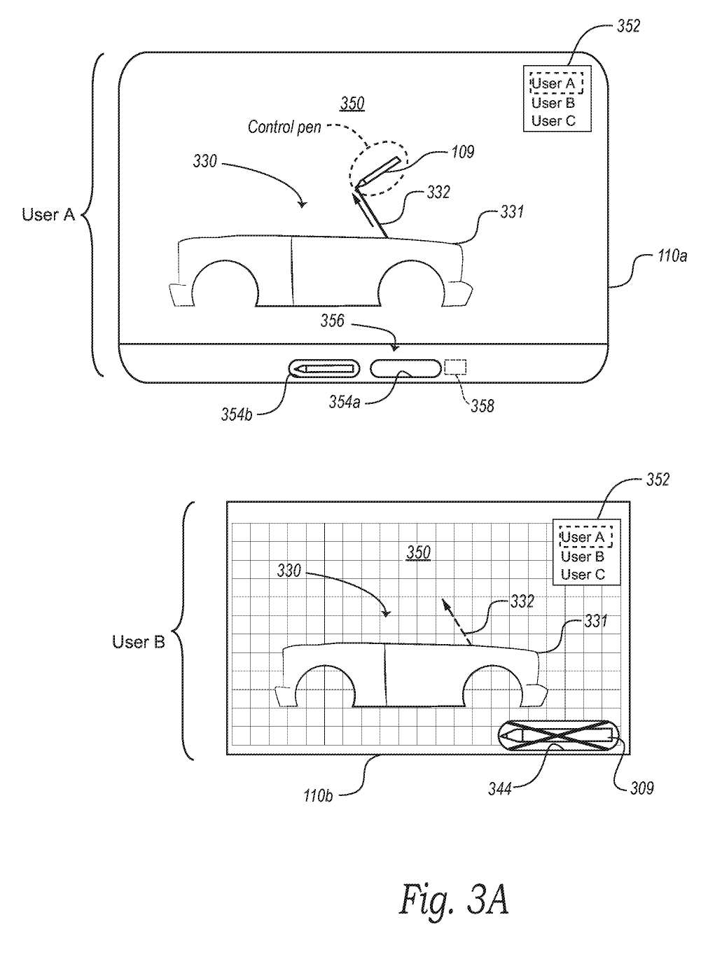

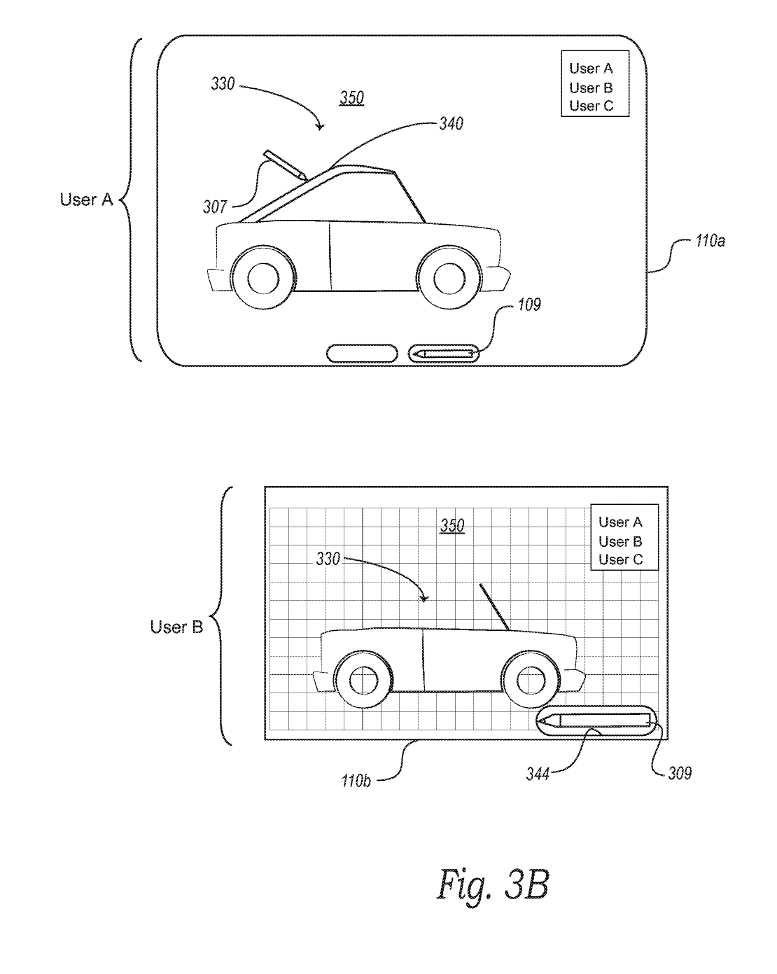

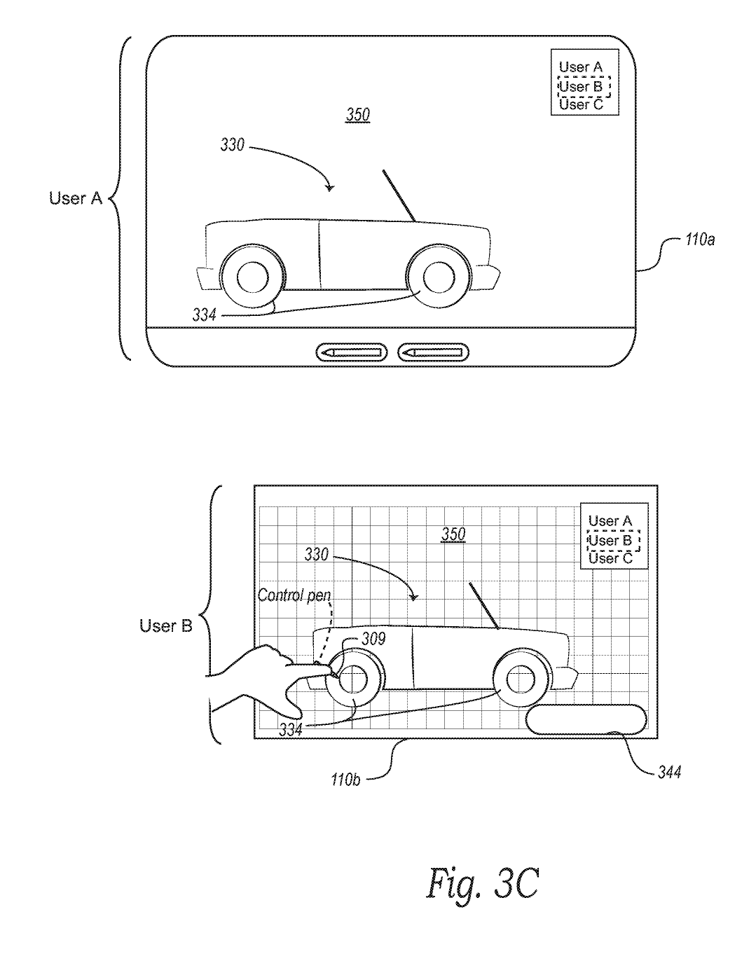

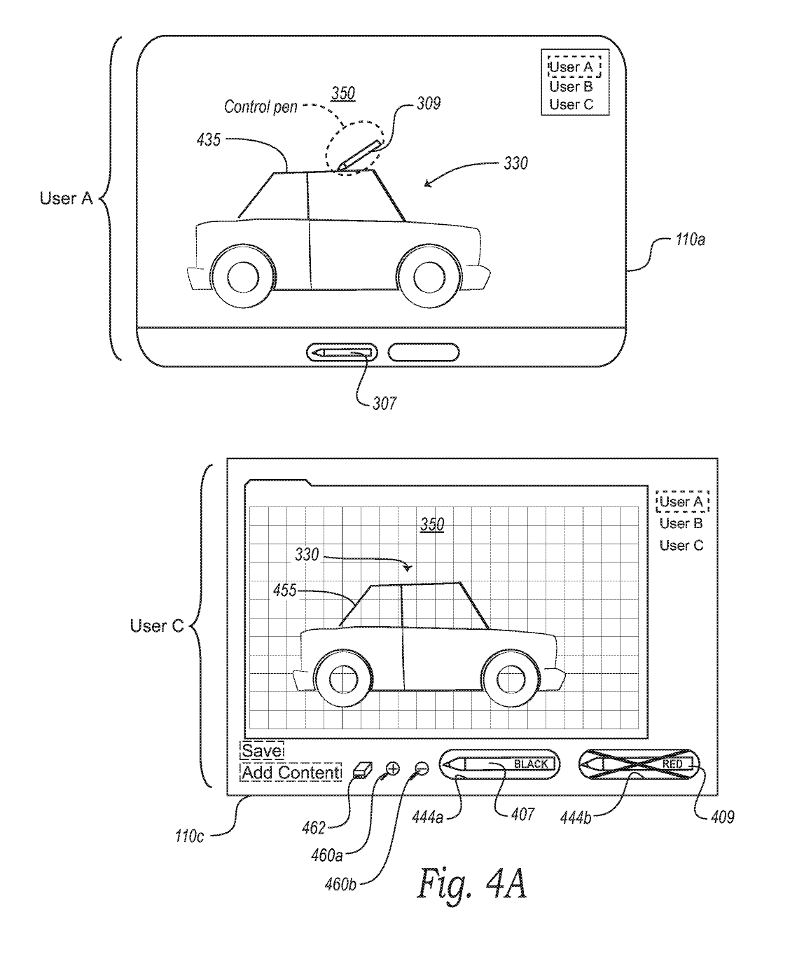

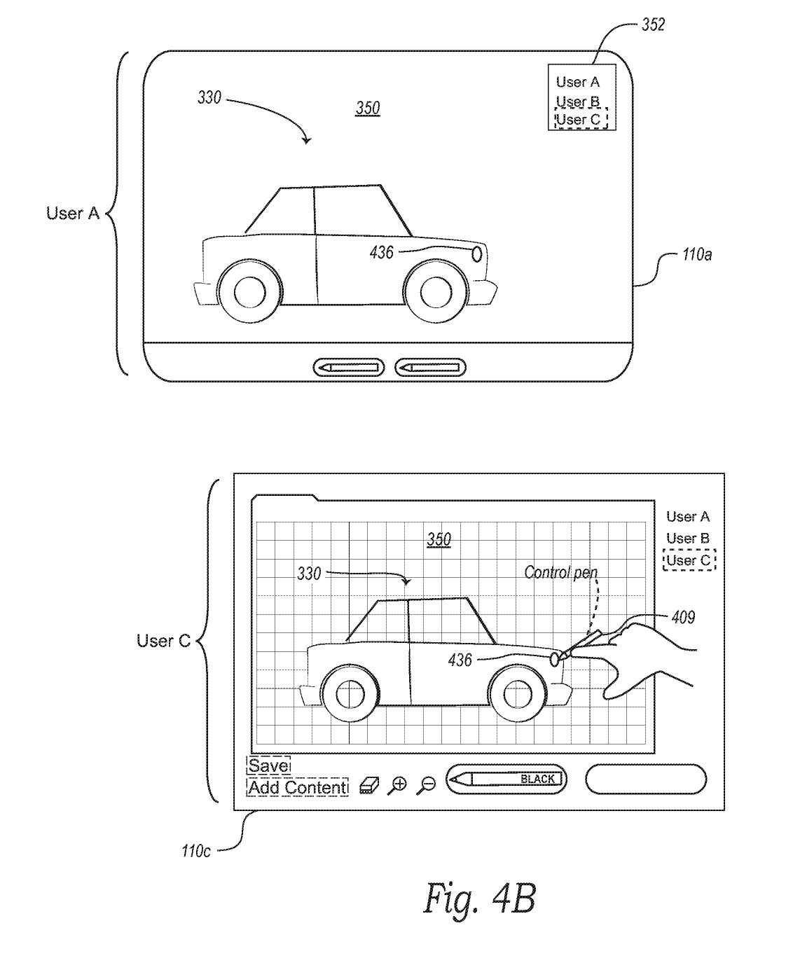

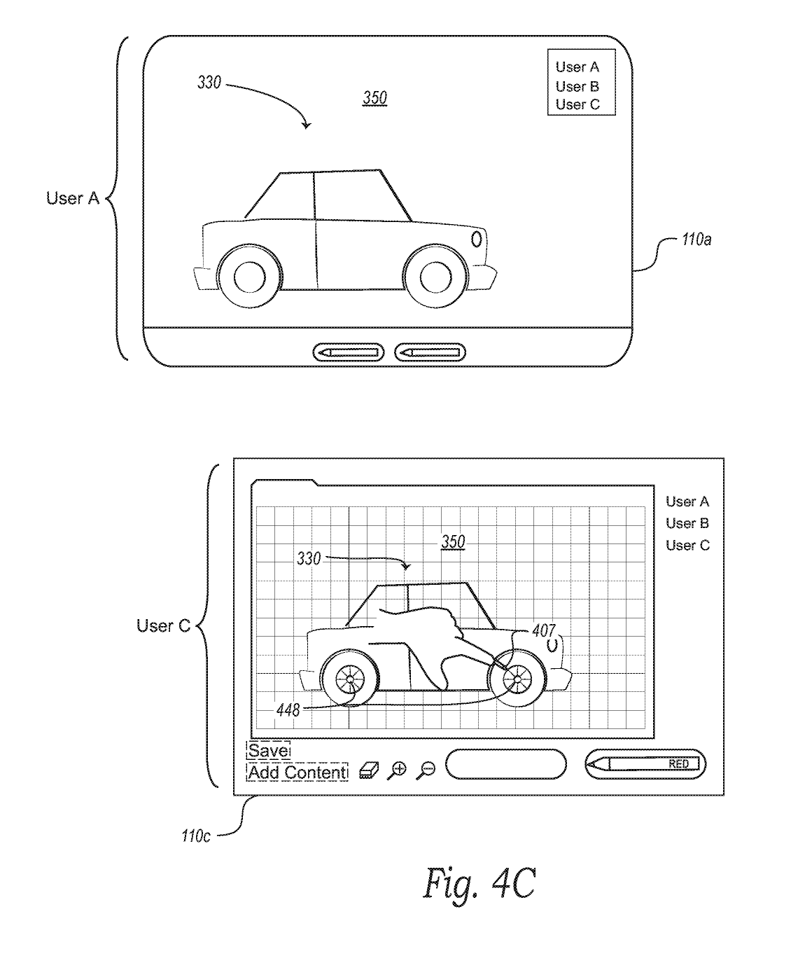

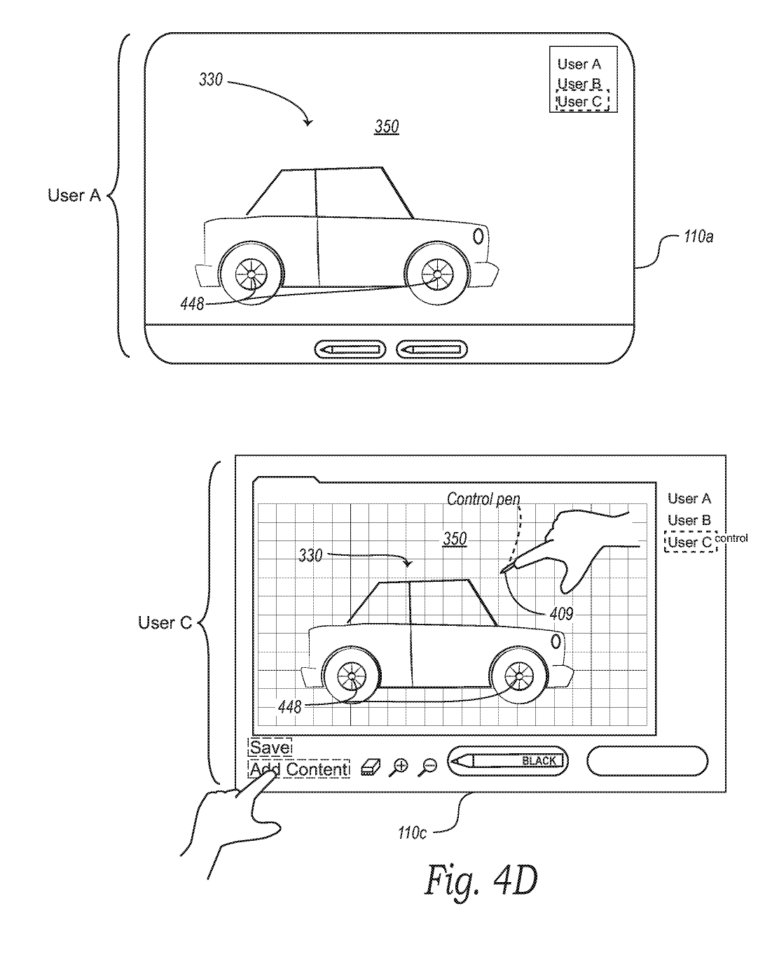

FIGS. 3A-4D are display diagrams illustrating some implementations of collaboration with a designated control pen. In the illustrated examples, Users A, B, and C participate in a collaboration session using a corresponding computing device, such as one of the display devices 106a-c (FIG. 1), respectively. In some embodiments, a collaboration session can include a larger or smaller number of users than shown (e.g., two, five, ten, fifteen, or more users). In various embodiments, the participants can be presented with a menu 352 showing a list identifying the current participants in the collaboration session. Each display device displays a digital canvas 350 and globally-displayed graphical content 330 (“global content 330”) on the canvas 350. Content 330 may reside in memory associated with one of the computing devices such as computing device 106a and/or server device 106f. As used herein, the terms “globally-displayed graphical content” and “global content” can refer to content that is displayed globally to each participant in the collaboration session at their corresponding display areas.

FIG. 3A shows the display areas 110a and 110b of Users A and B, respectively, with the physical pen 109 designated as the control pen (i.e., with User A designated as the presenter). In this example, the global content 330 includes existing content 331 (e.g., a drawing of car chassis) that has been drawn with the designated pen 109. User A has also modified the global content 330 by adding content 332 (e.g., a windshield) with the designated pen 109. As used herein, the term “modify” can refer to the initial creation of graphical content. The term “modify” can also be used to refer to adding, editing, or erasing portions of graphical content including injecting digital ink to annotate over existing digital objects or otherwise create new digital content.

When not in use, the physical pen 109 can be returned to a pen return area 356. In some embodiments, the pen return area 356 can include physical pen-tray or pen holders 354. The pen holders 354 can include, for example, a shelf, a recess, or other mechanical feature (e.g., a magnetic holder, a clip, etc.) such as those described in U.S. Pat. No. 8,619,027 assigned to the assignee of the present application. In some embodiments, the pen holders 354 can be integrated into a display bezel (not shown).

In various embodiments, a sensor 358 (shown in hidden lines) including control circuitry, may be implemented as an optical, magnetic, or other sensor, can be positioned near one or both of the pen holders 354. In operation, the sensor 358 detects whether a physical pen is in a “pick-up” state (e.g., removed from a pen holder) or in a “put-down state” (e.g., returned to a pen holder). When a pen tool is in a pick-up state, it is designated as the control pen. A pen in a put-down state is not designated as the control pen.

In some embodiments, the sensor 358 can determine whether a physical pen used to interact with display area 110a is in a pick-up state or a put-down state, regardless of whether a physical pen is physically held, by checking if a pen is placed within or removed from a pen holder. Moreover, the sensor 358 can be configured to detect gestures, such as tapping gestures made with the physical pen 109 or a finger, indicative of whether the pen is to be put in a pick-up state or put-down state. In some embodiments, a participant may tap once near the sensor 358 to pick-up the physical pen 109, and tap twice to put down the physical pen 109. In any case, when a physical pen used to interact with display area 110a, such as the physical pen 109, is determined not to have been picked up, due to sensor 358 being in a put-down state, the physical pen 109 is no longer designated as the control pen, as described below.

With reference still to FIG. 3A, the global content 330 modified by the designated control pen 109 is also modified at User B's display area 110b. Specifically, the content 332 is added to the existing content 331 of the global content 330 shown at the display area 110b. As described below, User B's display area 110b can include a virtual pen holder 344 (e.g., a soft button) containing a virtual pen 309. In the example of FIG. 3A, the virtual pen 309 is disabled (as shown by the “X”) because the physical pen 109 is designated as the control pen.

FIG. 3B shows the display areas 110a and 110b with no pen designated as the control pen (i.e., with no designated presenter). In this example, User A has added local content 340 (e.g., a passenger cabin) using a non-control pen 307. The non-control pen 307 can be similar to the physical pen 109, but may draw or write in a different color and/or have a different line width than the physical pen 109. In some embodiments, physical pens may have higher priority than virtual pens, and can thus wrestle control away from any virtual pen that is designated as control pen. In other embodiments, a specific pen, such as pen 109, may have a higher priority than another physical pen, such as pen 307. The system 100 (FIG. 1) does not detect whether the non-control pen 307 is in a pick-up state or a put-down state. In use, the participant can use the non-control pen 307 to draw local content that he or she does not wish to be globally displayed to other participants of the session. The non-control pen 307 does not affect or modify the shared global content 330. In various embodiments, a participant can use the non-control pen 307 to locally draw and sketch out certain ideas or concepts that he or she is currently contemplating. In one aspect, this enables a participant to sketch out these concepts without distracting the other participants away from the global content 330 that is globally presented. As described below, local content can be saved by a participant for recall at a display area at later time.

FIG. 3C shows the display areas 110a and 110b with the virtual pen 309 designated as the control pen (i.e., with User B designated as a presenter). In this example, User B has further modified the global content 330 by adding content 334 (e.g., wheels) using the designated pen 309. In the illustrated embodiment, the virtual pen 309 is represented as a pen cursor on the digital canvas 350 when it is in the pick-up state. In other embodiments, a different cursor (e.g., an arrow cursor) or no cursor may appear when the virtual pen 309 is in the designated pick-up state. In some embodiments, User B's pen cursor may appear on the display areas of the other participants as User B draws with the virtual pen 309.

User B can enable the virtual pen 309 by removing it from the virtual pen holder 344. In some embodiments, the virtual pen holder 344 can be a soft button that is selected to activate the virtual pen 309. In additional or alternate embodiments, the virtual pen 309 can be dragged (e.g., by the user's finger or a mouse curser) from the virtual pen holder 344 and onto the digital canvas 350. The virtual pen 309 can be returned to the virtual pen holder 344 in a similar fashion (e.g., by pushing a soft button and/or by dragging the virtual pen 309 back on to the virtual pen holder 344).

FIG. 4A shows the display areas 110a and 110c of User A and User C, respectively, with the physical pen 109 designated as the control pen (i.e., with User A designated as the presenter). The display areas 110a and 110c show the global content 330 shown in FIG. 3C, but User A has further modified the global content 330 with the designated pen 109 to include content 435 (e.g., a passenger cabin). In some embodiments, when User A picks up the physical pen 109, the system 100 (FIG. 1) can automatically designate the physical pen 109 as the control pen and automatically disable a virtual pen (e.g., the virtual pen 309; FIGS. 3A-3C). In such embodiments, the physical pen 109 can function as a master control pen, as discussed above.

As further shown in FIG. 4A, User C's display area 110c is similar to User B's display area 110b shown in FIGS. 3A-3C. For example, User C's display area 110c includes virtual pen holders 444a and 444b that contain first and second virtual pens 407 and 409, respectively. User C's display area 110c further includes additional graphical tools, including zoom tools 460 and an eraser tool 462.

The first virtual pen 407 can serve as a non-control pen and function in a manner similar to the non-control pen 307, discussed above. The virtual pen 409 can operate in a manner similar to the virtual pen 309 (FIGS. 3A-3C). For example, in FIG. 4A, the virtual pen 409 is disabled because the physical pen 109 is in a pick-up state. In some embodiments, pens that can be designated as a control pen (e.g., the pens 109 and 409) can be assigned a unique color (e.g., red). Non-control pens (e.g., the pens 307 and 407) can be assigned another unique color (e.g., black). In this way, participants can readily distinguish between graphical content (e.g., the global content 330) drawn with a designated control pen from local content drawn with a non-control pen.

FIG. 4B shows the display areas 110a and 110c with the second virtual pen 409 designated as the control pen (i.e., with User C designated as a presenter). In this example, User C has further modified the global content 330 by adding content 436 (e.g., a headlight) using the designated pen 409. FIG. 4C shows the display areas 110a and 110c with no pen designated as the control pen (i.e., with no designated presenter). In this example, the user has selected the non-control virtual pen 407 to draw local content 448 (e.g., hub caps). As described above, the local content 448 is not viewable at the displays of the other participants in the session. In some embodiments, the system 100 can save the local content 448 when User C presses a soft button labeled “Save”.

FIG. 4D shows the display areas 110a and 110c with the virtual pen 409 designated as the control pen (i.e., with User C designated as the presenter). In this example, User C has selected a soft button labeled “add content” button to add the local content 448 as part of the global content 330. The ability to save and add the local 448 can enable participants to add content that they have drawn while they were not in control of the control pen. In one aspect, this enables participants to draw content while a presenter is presenting, and subsequently convert or incorporate locally added content when the next participant becomes a presenter. For example, when User C becomes the presenter in FIG. 4D, the user can select the “Add content” button, which will display the content 448 on User A's display area 110a (and the other participants' display areas). The “Add content” button can be disabled when User C no longer has control of the virtual pen 409.

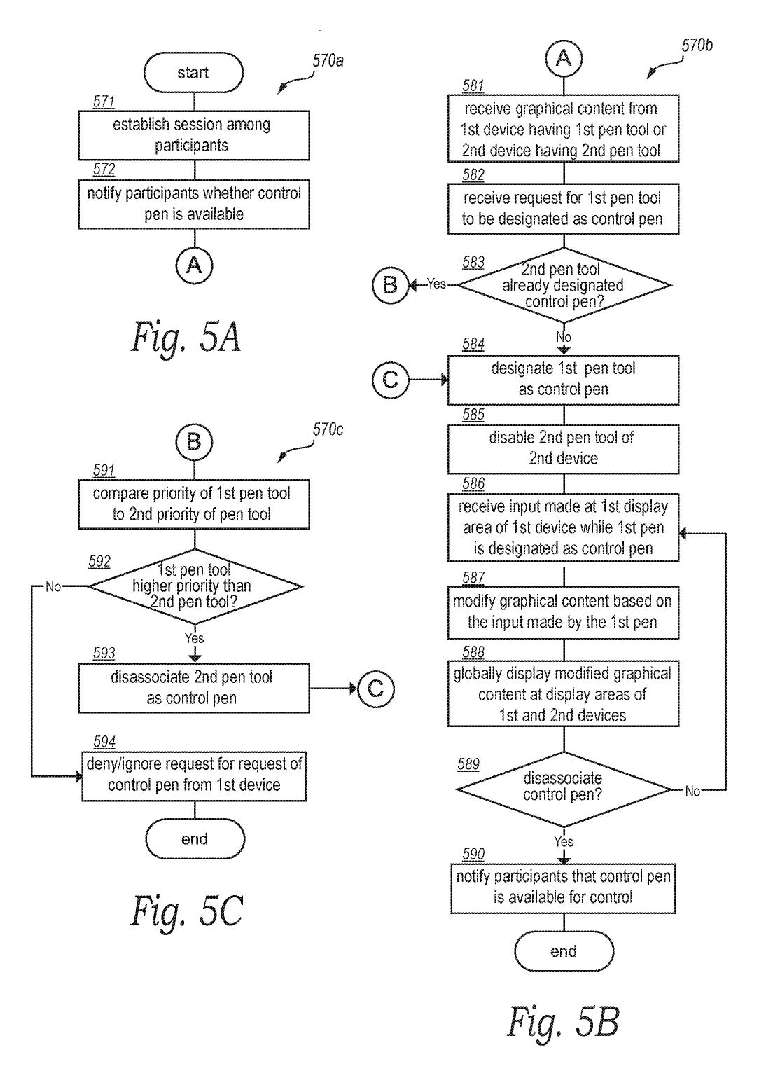

FIGS. 5A-5C are flow diagrams illustrating processes 570a-c, respectively, used by one or more computing devices hosting the shared global content 330 in some implementations for hosting a collaboration session using a control pen. As discussed above, a collaboration session host, such as the computing device 106a (Figurel) can provide the main presentation screen at which a digital canvas is displayed. One or more server devices, on the other hand, can be configured to facilitate (e.g., host) the collaboration session between various computing devices (e.g., the computing devices 106a-e) over a network, such as the network 108 (FIG. 1). In some embodiments, the processes 570 can be carried out in part by a collaboration host device and in part by one or more server devices. For example, in various embodiments the computing device 106a can carry out block 571 of process 570a, and server device 106f (FIG. 1) can carry out block 572 of process 570b. In these and other embodiments, the server device 106f can carry out processes 570b (FIG. 5B) and 570c (FIG. 5C) in whole or in part.

Referring to FIG. 5A, at block 571, the process 570a establishes a collaboration session between multiple participants and their corresponding computing devices. In some embodiments, the collaboration session can be initiated when a participant sends out invites to others to join the collaboration session. A session ID can be associated with the collaboration session, as discussed above. At block 572, the process 570a notifies the computing devices participating in the session whether the control pen is available for control, such as via, e.g., the participant menu 352 (FIG. 3A).

Referring to FIG. 5B, at block 581, the process 570b receives graphical from a computing device, such as a first computing device (e.g., the computing device 106a), or a second computing device (e.g., the computing device 106b). The first and second computing devices have associated first and second pen tools, such as physical and/or virtual pen tools. The graphical content can be modified globally with one of the first and second pen tools when it is designated as the control pen. However, only one of the first and second pen tools can be designated as a control pen at any given time.

At block 582, the process 570b receives a request for the control pen from the first computing device for the first pen tool to be designated as the control pen. In some embodiments, the request can be sent from a computing device when it detects that a pen has been removed from a pen return area, a pen holder, or a user has pressed a soft button, as discussed above.

At block 583, the process 570b determines whether the second pen tool (or another pen tool) is designated as the control pen. If so, the process 570b proceeds to block 591 (FIG. 5C) to compare the priorities of the pen tools, otherwise the process 570b proceeds to block 584 to designate the first pen tool as the control pen. As discussed above, the presenter with the control pen becomes the presenter of the collaboration session. At block 585, the process 570b disables or otherwise prevents the second computing device and other participants from modifying global content (i.e., globally-displayed graphical content) via their corresponding physical and/or virtual pens. In some embodiments, such preventing can include notifying the other participants' computing devices which participant is in control of the control pen (via, e.g., the participant menu 352 shown in FIG. 3A). In response to such a notification, the process 570b can instruct these computing device to perform actions such as disabling a soft button (used, e.g., for activing a virtual pen), ignoring interactions made by the other participants' pens, or otherwise preventing a pen tool from being used to modify the global content. In some embodiments, a computing device may disable a physical pen by preventing it from producing digital ink on the digital canvas and/or disregarding any interactions that it may detect from the physical pen when it is not identified as the control pen.

At blocks 586 and 587, the process 570b receives input from the first computing device based on interactions made by the first pen tool, such as interactions made by a presenter at a corresponding display area. At block 588, the process 570b provides the graphical content to the first and second computing devices and any other participants for display at their corresponding display area. As discussed above, the modified graphical content is globally displayed to the other users on the common digital canvas. In various embodiments, the process 570b can provide the graphical content to the other participants in the session in real-time or near real-time as the participant in control of the control pen is modifying the content. In such embodiments, the process 570b may provide only the new or modified portions of the global content to reduce bandwidth of the communications sent between the computing devices in the session. For example, rather than re-sending the entire global content, these communications can indicate selected line vectors, regions, or others areas of the content that have been deleted or added; changed in shape, color, or pattern; or otherwise changed in visual appearance.

At block 589, the process 570b determines whether to disassociate (e.g., release) the control pen from the current presenter's pen tool. The process 570b may release the control pen, for example, when a computing device notifies the process 570b that a pen tool has been returned to a pen holder, a soft button has been pushed to de-active a pen, etc. The process 570b can then notify the other participants that the control pen is again available via, e.g., the participant menu 352 (FIG. 3A).

As discussed above, other participants not in control of the control pen can be allowed to locally create and modify content that is not globally displayed, but displayed at their corresponding devices. In some embodiments, the process 570b may enable a subsequent presenter to add or append such local graphical content to the global content once the subsequent presenter gains control of the control pen, as discussed above. For example, the process 570b may add or append the local content in response to a presenter pushing the “add content” soft button described above with reference to FIGS. 4C and 4D. However, the process 570b may only enable a participant to do so when they are in control of the control pen.

In some embodiments, the request received at block 583 may be a request for master control of the control pen from a participant who is allowed to have master control of the control pen. In such cases, and referring to FIG. 5C, the process 570c may compare the priority of the first pen tool to the second pen tool (block 591) or other pen tools to determine the first pen tool's relative priority. The process 570c may release the control of a pen tool (blocks 592 and 593) when a pen tool has a relatively higher priority. The process can automatically render control of the control pen to the participant with a higher priority by returning to block 584 (FIG. 5B). Otherwise, the process 570c may ignore, deny, or otherwise disregard a request for a control pen (block 594), such as the request for the control pen at block 582 (FIG. 5B). In some embodiments, a physical pen tool can have a higher property than all virtual control pens in a collaboration session. In these and other embodiments, a physical pen tool can have a higher priority over another physical pen tool or the highest priority over all physical pen tools in a collaboration session.

In some embodiments, different levels of priority can be assigned to different users. For example, a teacher may have a pen tool with a higher priority level (e.g., master control) than the priority level of her student. Master control can be assigned to a single participant of the session, such as the participant that originated the session, or a selected group of selected participants. Control of the control pen cannot be taken away from a participant who has master control of the control pen. In some embodiments, master control can enable a presenter to intervene in a collaboration session. For example, master control can enable a teacher to intervene in a classroom environment in which some students may not readily relinquish control of the control pen.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

From the foregoing, it will be appreciated that specific embodiments of the disclosure have been described herein for purposes of illustration, but that various modifications may be made without deviating from the spirit and scope of the various embodiments of the disclosure. Further, while various advantages associated with some embodiments of the disclosure have been described above in the context of those embodiments, other embodiments may also exhibit such advantages, and not all embodiments need necessarily exhibit such advantages to fall within the scope of the invention. Accordingly, the disclosure is not limited, except as by the appended claims.

1. A method for providing a collaboration session, the method comprising:
receiving graphical content from either a first computing device associated with a first pen tool configured to interact with a first display area, or
a second computing device associated with a second pen tool configured to interact with a second display area;
receiving a request from the first computing device for the first pen tool to be designated as a control pen;
in response to the request, designating the first pen tool as the control pen and disabling the second pen tool so long as the first pen tool is designated as the control pen;
receiving input made at the first display area by the first pen tool while it is designated as the control pen;
modifying the graphical content based on the input; and
globally displaying the modified graphical content, wherein globally displaying the modified graphical content includes providing the modified graphical content to the first computing device for display at the first display area and to the second computing device for display at the second display area.

2. The method of claim 1 wherein the first pen tool has a first priority, and the second pen tool has a second priority, and wherein the method further comprises:
while the first pen is designated as the control pen, receiving a request from the second computing device for the second pen tool to be designated as the control pen; and
in response to the request from the second computing device either designating the second pen tool as the control pen when the second priority is higher than the first priority, or maintaining the designation of the first pen tool as the designated control pen when the first priority is higher than second priority.

3. The method of claim 2 wherein:
the first pen tool is a physical pen tool;
the second pen tool is a virtual pen tool; and
the first priority is higher than the second priority.

4. The method of claim 2 wherein:
the first computing device is a collaboration host device;
the second computing device is remotely coupled to the collaboration host device;
the first pen tool is a physical pen tool configured to interact with a presentation screen operably coupled to the collaboration host device;
the second pen tool is a physical pen tool; and
the first priority is higher than the second priority.

5. The method of claim 1, wherein the request is a first request, and wherein the method further comprises:
dissociating the first pen tool with the control pen;
receiving a second request from the second computing device for the second pen tool to be designated as the control pen;
in response to the second request, designating the second pen tool as the control pen; and
further modifying the graphical content based on the interactions made with the second pen tool when it is designated as the control pen,
wherein globally displaying the graphical content further includes providing the further modified graphical content to the first computing device for display at the first display area.

6. The method of claim 1 wherein the second computing device is configured to display a virtual pen holder, and wherein the disabling includes preventing the second pen tool from being removed from the virtual pen holder.

7. The method of claim 1 wherein receiving the request includes receiving the request in response to detecting that the first pen tool has been physically removed from a pen return area.

8. The method of claim 7 wherein the second computing device is configured to display a virtual pen holder, and wherein the disabling includes preventing the second pen tool from being removed from the virtual pen holder while the first pen tool is physically removed from the pen return area.

9. The method of claim 1 wherein the request is a first request, and wherein the method further comprises:
receiving a second request to further modify the graphical content based on third interactions made by a third pen tool while the first pen tool was designated as the control pen;
dissociating the first pen tool with the control pen; and
further modifying the graphical content based on the third interactions after the first pen tool has been released.

10. The method of claim 9, further comprising:
receiving the second request from the first computing device; and
providing the further modified graphical content to the second computing device for display.

11. The method of claim 9, further comprising:
receiving the second request from the second computing device; and
providing the further modified graphical content to the first computing device for display.

12. A computer-readable storage medium storing instruction that, when executed by a computing system, cause the computing system to perform operations for providing a collaboration session at least between first and second computing devices configured to receive graphical content, wherein the first computing device is associated with a physical pen tool configured to interact with a first display area, and wherein the second computing device is associated with a virtual pen tool configured to interact with a second display area, and wherein the operations comprise:
receiving a request from the first computing device for the physical pen tool to be designated as a control pen;
in response to the request, designating the physical pen tool as the control pen and disabling the virtual pen tool so long as the physical pen tool is designated as the control pen;
modifying the graphical content based on the interactions made with the designated control pen at the first display area; and
globally displaying the graphical content, wherein globally displaying the graphical content includes providing the modified graphical content to the second computing device for display at the second display area.

13. The computer-readable storage medium of claim 12 wherein the physical pen tool has a first priority, and wherein the operations further comprise:
while the physical pen tool is designated as the control pen, receiving a request from another computing device for another pen tool to be designated as the control pen, wherein the other pen tool has a second priority; and
in response to the request from the other computing device either designating the other pen tool as the control pen when the second priority is higher than the first priority, or maintaining the designation of the physical pen tool as the designated control pen when the first priority is higher than second priority.

14. The computer-readable storage medium of claim 12 wherein the request is a first request, and wherein the operations further comprise:
dissociating the physical pen tool with the control pen;
receiving a second request from the second computing device for the virtual pen tool to be designated as the control pen;
in response to the second request, designating the virtual pen tool as the control pen, and
further modifying the graphical content based on the interactions made with the virtual pen tool when it is designated as the control pen,
wherein globally displaying the graphical content further includes providing the further modified graphical content to the first computing device for display at the first display area.

15. The computer-readable storage medium of claim 14 wherein the operations further comprise:
while the virtual pen tool is designated as the control pen, receiving a third request from the first computing device for control of the control pen; and
in response to the third request, dissociating the virtual pen tool with the control pen and designating the physical pen tool as the control pen.

16. The computer-readable storage medium of claim 14, further comprising determining that the physical pen tool has been returned to a pen holder, wherein dissociating the physical pen tool with the control pen includes dissociating the physical pen tool in response to the determination.

17. The computer-readable storage medium of claim 12 wherein the second computing device is configured to display a virtual pen holder, and wherein the disabling includes preventing the virtual pen tool from being removed from the virtual pen holder while the physical pen tool is physically removed from a physical pen holder.

18. A computing system for providing a collaboration session, the system comprising:
a first computing device configured to display graphical content at a first display area and to detect interactions made using a first pen tool at the first display area;
a second computing device configured to display the graphical content at a second display area and to detect interactions made using a second pen tool at the second display area; and
a third computing device comprising a computer-readable storage medium storing instructions that, when executed by the third computing device, cause the computing system to perform operations, the operations comprising—
receiving a request from the first computing device for control of a control pen,
in response to the request, identifying the first pen tool as the control pen and preventing the second pen tool from modifying the graphical content,
modifying the graphical content based on the interactions made using the first pen tool when it is identified as the control pen, and
providing the modified graphical content to the second computing device for display at the second display area.

19. The system of claim 18, wherein the request is a first request, and wherein the operations further comprise:
releasing the first pen tool from being identified as the control pen;
receiving a second request from the second computing device for control of the control pen;
identifying the second pen tool as the control pen in response to the second request;
further modifying the graphical content based on the interactions made using the second pen tool when it is identified as the control pen; and
providing the further modified graphical content to the first computing device for display.

20. The system of claim 18 wherein the operations further comprise:
while the second pen tool is identified as the control pen, receiving a third request from the first computing device for control of the control pen; and
in response to the third request, releasing the second pen tool from being identified as the control pen and identifying the first pen tool as the control pen.
